(19) United States
(12) Patent Application Publication
(10) Pub. No.: US 2020/0391165 A1
(43) Pub. Date: Dec. 17, 2020

(54) FOOD PROCESSING SYSTEM AND ASSOCIATED METHOD

(71) Applicant: SOCIETE DES PRODUITS NESTLE S.A., Vevey (CH)

(72) Inventors: Youcef Ait Bouziad, Echandens (CH); Jean-Marc Flick, Pomy (CH); Sheldon Femandes, La Tour-de-Peilz (CH); Fabien Ludovic Agon, Valeyres-Sous-Rances (CH)

(21) Appl. No.: 16/971,064

(22) PCT Filed: Feb. 6, 2019
(86) PCT No.: PCT/EP2019/052835

§ 371 Date: Aug. 19, 2020

(30) Foreign Application Priority Data
Feb. 20, 2018 (EP) 18157625.7

(51) Int. Cl. B01F 7/00; B01F 7/24; B01F 13/10; B01F 15/02; B01F 15/00; A23P 30/00; A23L 5/00; A23L 5/10; B01F 15/06; B01F 3/12

(52) U.S. Cl. CPC B01F 7/00058; B01F 2015/062; B01F 7/00425; B01F 7/00325; B01F 7/00441; B01F 7/24; B01F 13/1066; B01F 15/027; B01F 15/0279; B01F 15/0289; B01F 15/00188; B01F 15/00396; A23P 30/00; A23L 5/55; A23L 5/10; B01F 15/066; B01F 3/1221; B01F 3/1207; A23V 2002/00; B01F 2215/0014; B01F 7/00225

(57) ABSTRACT

The invention relates to a food processing system (100) for preparing an edible mass of a food product starting from a raw food material, the system comprising: —one or a plurality of food containers (20), each one comprising a raw food material in form of dehydrated material and/or paste and/or chunks; —one or a plurality of dispensing and reconstituting chambers (10), each chamber being associated to at least one food container (20), each of the chambers (10) comprising a variable and/or exchangeable reconstitution and deposition device configured for hydrating and/or structuring and/or reconstituting in batches the raw food material provided by the one or more food containers (20) in order to create a homogeneous edible mass of food product, the device being further configured to deposit in-line with a controlled flow the edible mass of food product once prepared. The invention further relates to a method for operating a food processing system (100) as the one described in order to prepare an edible mass of food product starting from raw food material: the information on the kind of raw food material and on its processing is retrieved from identification means on the one or more food containers (20) and/or from a connected database, in order to process the raw food material in the one or more of the dispensing and reconstituting chambers (10) according to a certain recipe, acting on the hydration ratio and/or mixing speed and/or mixing time and/or temperature and/or viscosity and/or texture

### FIELD OF THE INVENTION

The present invention is directed to a dispensing and reconstituting unit used in a food processing system. The invention further relates to the said food processing system, as well as to a method for operating the said system for preparing an edible mass from a raw material.

### BACKGROUND OF THE INVENTION

Dried or semi-dried food products, typically configured as powders, are used very frequently in the food industry: they represent compact and hygienic ways of storing an initial component of a food product that will be subsequently processed, for example by mixing and adding water or any other liquid, being therefore reconstituted.

There exist in the state of the art food processing systems that prepare edible layers of food starting from raw food materials, typically in powder. For example, document EP 16722568.9 of the applicant discloses a food processing system comprising a plurality of containers, each container comprising a certain raw food material, typically a powder. Each container is associated to a processing and dispensing unit: the initial raw material from the container goes into the specific unit where it is processed typically by adding water and the resulting mixture is turned into a homogeneous mass before being deposited as a layer onto a depositing area, where the layer can be optionally further cooked and/or heated.

It is known also from the applicant document PCT/EP17/076941 disclosing a food processing management system: the system comprises a control unit connected to a dosing system for exchanging containers, each container comprising a certain type of dehydrated food material, typically a powder, that is sent into a processing and dispensing unit where it is mixed with water and turned into a homogeneous mass that will be deposited as a layer onto a depositing area, the layer being later optionally heated and/or cooked.

The food processing systems described earlier have many advantages but also present certain limitations. As an example, it would be desirable to have different products mixed together, products coming from different containers that will constitute a certain mixture: for example, powder from one of the containers, chunks from another one, such that water will be added to both in order to process the mixture and constitute a certain mass. Furthermore, some products cannot be stored together in the same storage container as they react with each other under long storage times; thus, these products should be only mixed just before they will be prepared for deposition, i.e. in the last minute. Moreover, in the known systems, it is hard to control the mixing and processing time that is adequate to each food product prepared: depending on the product, the hydration time varies and some products need specifically more time for getting the correct hydration. Therefore, it would be desirable to control the time for each of the dehydrated food materials, more particularly when several ones are mixed from different containers. Furthermore, it would be highly advantageous to be able to provide different processed products (coming from different mixtures, from different containers) in certain sequences: for example, such a sequence could be to mix a powder coming from a first container with water, mixing them both to get a paste, then add chunks or pieces to the so-formed paste, mix only in a very low degree and finally dispense the obtained mixture.

Certain pastes and edible masses need a certain amount of energy and processing time, ideally in batches, such as shearing and heating, to create a texture network such as gluten network, proteins network or the like. For this purpose, a batch processing is desirable, as the residence time can be controlled according to a certain recipe. On the contrary, an in-line system (i.e. a system working on demand) as the one disclosed in PCT/EP17/076941, not working in batches, would need very complex, long and extended configurations for arriving to control the process as it is the case in the present invention, further controlling the processing parameters of each product differently, also according to the final desired recipe.

It would also be desirable that the system could have two or more processes ongoing at the same time or taking place in batches, when there would be two or more processing and dispensing units: for example, a first unit would be dispensing the already prepared product while a second unit would be preparing in batch a second product to be dispensed at a later stage. Then, once the second unit would be ready and would be dispensing the prepared product, the first unit would start to prepare a product that will be dispensed later. Under this batch sequencing, the food processing system of the invention will allow proper control for each batch and/or product prepared, with yet a simple and compact configuration.

The present invention aims at overcoming the limitations mentioned in the existing food processing systems. The invention also aims at other objects and particularly the solution of other problems as will appear in the rest of the present description.

### OBJECT AND SUMMARY OF THE INVENTION

According to a first aspect, the invention relates to a food processing system for preparing an edible mass of a food product starting from a raw food material. The system comprises: one or a plurality of food containers, each one comprising a raw food material in form of dehydrated material and/or paste and/or chunks; one or a plurality of dispensing and reconstituting chambers, each chamber being associated to at least one food container, each of the chambers comprising a variable and/or exchangeable reconstitution and deposition device configured for hydrating and/or structuring and/or reconstituting in batches the raw food material provided by the one or more food containers in order to create a homogeneous edible mass of food product, the device being further configured to deposit in-line with a controlled flow the edible mass of food product once prepared.

Preferably, in the food processing system of the invention, the one or plurality of dispensing and reconstituting chambers are relatively moveable with respect to the one or plurality of food containers and/or are relatively moveable with respect to a deposition area where the mass of food product is deposited.

Typically, the reconstitution and deposition device in the food processing system of the invention is configured as a unique device, configurable under two different profiles, one for hydrating and/or structuring and/or reconstituting and another one for depositing.

According to one embodiment of the invention, the reconstitution and deposition device can adopt the different profiles by rotating in opposite directions or by manual or commanded switching.

According to another embodiment of the invention, the reconstitution and deposition device comprises exchangeable tools for hydrating and/or structuring and/or reconstituting, and for depositing, working sequentially within the same dispensing and reconstituting chamber.

Yet according to another embodiment of the invention, the reconstitution and deposition device comprises two distinct tools for hydrating and/or structuring and/or reconstituting, and for depositing, coexisting in the same dispensing and reconstituting chamber, the tools being activated separately or in combination according to the needs for hydrating and/or structuring and/or reconstituting, and for depositing. Typically, the two distinct tools are activated by two distinct motors, independently commanded, the activation of these tools being done simultaneously or sequentially, at the same or different speed and/or direction.

Preferably, in the food processing system of the invention, one or more of the dispensing and reconstituting chambers are provided with injection means for a controlled and homogenous water injection into the chamber, in the form of a jet, a spray or the like.

Typically, one or more of the dispensing and reconstituting chambers in the food processing system of the invention, are provided with sensing means to measure one or more characteristics of the edible mass of the food product prepared therein, such as temperature, viscosity, pH, or the like and/or to measure characteristics of the operation of the chambers such as motor torque, motor current or the like.

Preferably, one or more of the dispensing and reconstituting chambers are provided with sensing means to measure the deposition flow rate of the edible mass of food product prepared.

In the food processing system of the invention, one or more of the dispensing and reconstituting chambers can be provided with heating means to control the temperature of the edible mass of food product prepared therein.

Typically, one or more of the food containers in the food processing system of the invention comprise identification means with information to identify the kind of raw food material contained and the information on its processing according to a certain recipe.

Preferably, the food processing system of the invention further comprises cooking means able to cook at least part of the edible mass of food product deposited onto the deposition area.

According to a second aspect, the invention relates to a method for operating a food processing system as the one described in order to prepare an edible mass of food product starting from raw food material, wherein the information on the kind of raw food material and on its processing is retrieved from identification means on the one or more food containers and/or from a connected database, in order to process the raw food material in the one or more of the dispensing and reconstituting chambers according to a certain recipe, acting on the hydration ratio and/or mixing speed and/or mixing time and/or temperature.

Preferably, in the method of the invention, the temperature of the edible mass of food product in the one or plurality of dispensing and reconstituting chambers is controlled along time and depending on the type raw food material being processed therein.

Typically, in the method of the invention, a different raw material in the form of chunks, pieces or the like is added to the one or plurality of dispensing and reconstituting chambers after a first processing of edible mass has started, the complete mixture being later re-mixed for homogenization and further deposition.

In the method of the invention, preferably, the edible mass of food product from one or a plurality of dispensing and reconstituting chambers is deposited onto a deposition area, where it is then treated by being cooked at least partially and/or it is controlled for a certain reaction such as a volume increase, before a further edible mass is deposited onto the area.

Typically, in the method according to the present invention, the edible mass of food product prepared by one or more of the dispensing and reconstituting chambers is deposited in different steps, while the dispensing and reconstituting chambers continue processing the food mass contained therein in order to maintain certain characteristics of the food mass, typically its viscosity.

In the method of the present invention, typically part of the content of the edible food mass in one of the dispensing and reconstituting chambers can be dispensed onto a deposition area, while the remaining food mass in the chamber is mixed with a different product in the form of chunks and/or pieces, which will be deposited further onto the area having a different texture than the one of the first mass deposited.

### BRIEF DESCRIPTION OF THE DRAWINGS

Further features, advantages and objects of the present invention will become apparent for a skilled person when reading the following detailed description of embodiments of the present invention, when taken in conjunction with the figures of the enclosed drawings.

FIG. 1 shows a general overview of a food processing system of the present invention.

FIG. 2 shows a frontal view of the food processing system of the invention shown in FIG. 1.

FIGS. 3a-b show the configuration of an integrated tool allowing both dispensing and reconstituting, used in a food processing system according to the present invention.

FIGS. 4a-b show the configuration of an integrated tool allowing both dispensing and reconstituting according to another possible embodiment, used in a food processing system according to the present invention.

FIG. 5 shows a further view of an integrated tool allowing both dispensing and reconstituting according to the embodiment shown in FIGS. 4a-b.

FIG. 6 shows a possible embodiment of the configuration of a dispensing and reconstituting chamber used in a food processing system according to the present invention.

FIGS. 7a-c show details of the dispensing and reconstituting chamber according to the embodiment shown in FIG. 6, used in a food processing system according to the present invention, showing different steps of the mixing and dispensing process.

FIGS. 8a-c show details of the external configuration of the dispensing and reconstituting chamber according to the embodiment of FIG. 6, used in a food processing system according to the present invention.

FIG. 9a shows a detail of the pushing element used in a dispensing and reconstituting chamber according to the embodiment of FIG. 6, used in a food processing system according to the present invention.

FIG. 9b shows in detail the elements configuring the pushing element used in a dispensing and reconstituting chamber according to the embodiment of FIG. 6, used in a food processing system according to the present invention.

FIGS. 10a-c show another possible embodiment of a dispensing and reconstituting chamber used in a food processing system according to the invention.

FIGS. 11a-b show in detail the inner configuration of a dispensing and reconstituting chamber as shown in FIGS. 10a-c used in a food processing system according to the invention.

### DETAILED DESCRIPTION OF EXEMPLARY EMBODIMENTS

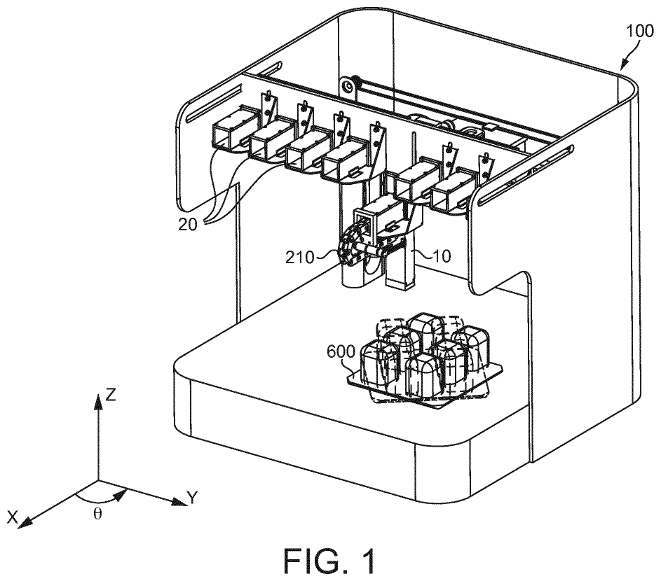

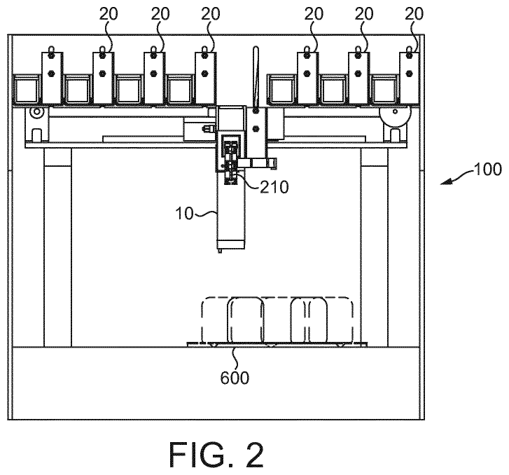

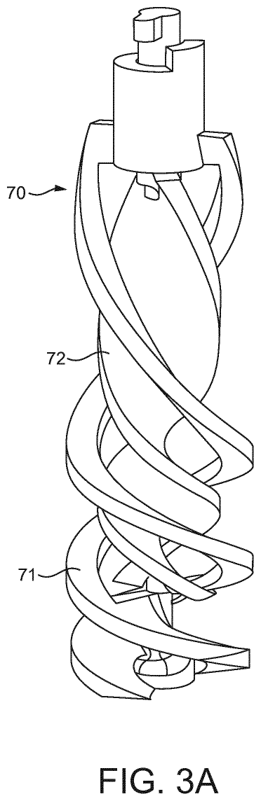

The invention relates to a food processing system 100 as represented in FIGS. 1 and 2. The system comprises several food containers 20, each one of them comprising a raw food material in the form of dehydrated material, typically powder, and/or paste and/or pieces or chunks. Each food container 20 typically comprises a different product so that different mixtures can be prepared with the system of the invention. Of course, there may be more than one food container 20 comprising the same raw food material, typically the material that is used with a higher frequency in the standard recipes prepared with the system, for example.

The required amount of raw food product from a certain food container 20 is transferred into a dispensing and reconstituting unit 10 by means of a dosing device 210, which controls the exact amount of product transferred from each of the containers 20. Some raw food products cannot be stored together as they react with each other, particularly after a long time storage. Therefore, each different food product is stored in a different food container 20 until the moment it is mixed to prepare a recipe in the system 100.

Depending on the recipe that will be prepared by the system, a certain content of one container 20 or from several food containers 20 is transferred in a correct dosage by means of the dosing device 210 into a dispensing and reconstituting unit 10. The raw food material is then hydrated (typically by adding water to it) and/or structured and/or reconstituted (typically by mixing action from rotating elements homogenizing the mix content) into the dispensing and reconstituting unit 10 and is later dispensed onto a deposition area 600, as shown in any of FIG. 1 or 2. In the embodiment of FIG. 1 or FIG. 2, the system comprises only one dispensing and reconstituting unit 10, so only one mixture of product can be prepared at the time, can be deposited at the time, and then later a second mixture of product will be prepared and further dispensed by the same dispensing and reconstituting unit 10. However, the system 100 may also comprise a plurality of dispensing and reconstituting units 10, according to another embodiment of the invention: in such a case, one product prepared in one of the units 10 will be dispensed and, at the same time, another product will be prepared in parallel in a second unit 10, so that it can be dispensed just after the first one has been dispensed. This provides a highly efficient process, working in batches, as it will be further described in more detail when referring to the method of the invention.

In order to provide different shapes and/or layers of food product deposited onto the deposition area 600, the dispensing and reconstituting unit 10 is moveable with respect to the deposition area 600, in axis X and/or Y and/or Z. It is also possible that it is the deposition area 600 the one that is moveable in axis X and/or Y and/or Z, or that both of them (the deposition area 600 and the dispensing and reconstituting unit 10) are moveable in axis X and/or Y and/or Z.

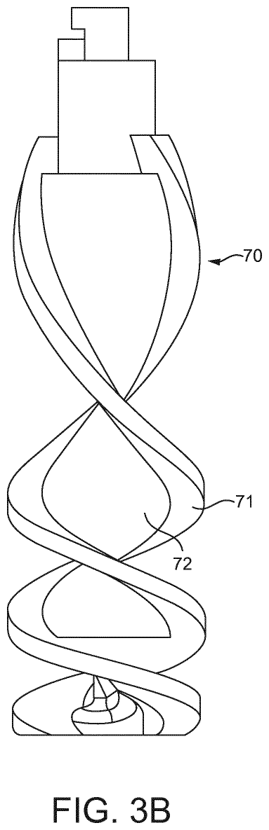

The dispensing and reconstituting chamber 10 in the system 100 of the invention comprises a product inlet 11 through where the food product (typically a powder) coming from a container 20 is introduced inside the chamber 10. The dispensing and reconstituting chamber 10 is connected to a container 20 through this product inlet 11. The dispensing and reconstituting chamber 10 is further provided with a fluid inlet 12, through where a fluid, typically water, is provided inside the chamber 10 in order to hydrate and/or reconstitute and/or structure the raw food product from the one or plurality of containers 20. Furthermore, the dispensing and reconstituting chamber 10 comprises inside a reconstitution and deposition device that can adopt different configurations according to different embodiments of the invention: this reconstitution and deposition device is configured for hydrating and/or structuring and/or reconstituting the raw food material, typically mixing it well with water coming through a fluid inlet 12, in order to create a homogeneous edible mass of food product. The different possible embodiments configuring different dispensing and reconstituting chambers 10 will be now presented in further detail, referring to FIGS. 3a-b to 11a-b.

The fluid inlet 12 can also be provided with injection means (not shown) for a controlled and homogeneous fluid injection (typically water) into the dispensing and reconstituting chamber 10 in the form of a jet, a spray or the like.

Looking at FIGS. 3a-b, 4a-b and 5 they represent a reconstitution and deposition device 70 having a variable configuration. One possible embodiment of this device 70 is that it is provided with two different separate blades 71 and 72, which are moveable with respect to each other, so that they can adopt an open profile (as shown in FIG. 3a) or a closed profile (as shown in FIG. 3b). The open profile in FIG. 3a is adopted when the mixture, hydration or reconstitution of the raw food material with a fluid is being done. When a closed configuration as the one represented in FIG. 3b is adopted, the two blades 71 and 72 come together: this configuration is used for delivering or depositing the food product, once prepared, onto a deposition area 600. Typically, the blades 71 and 72 rotate with respect to each other, around a common longitudinal axis, to adopt the two different positions shown in FIGS. 3a and 3b.

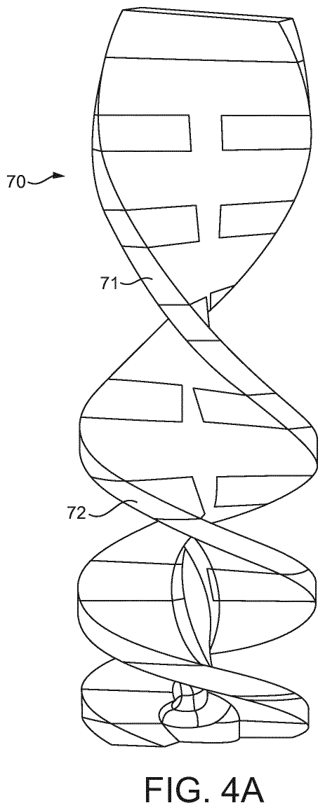

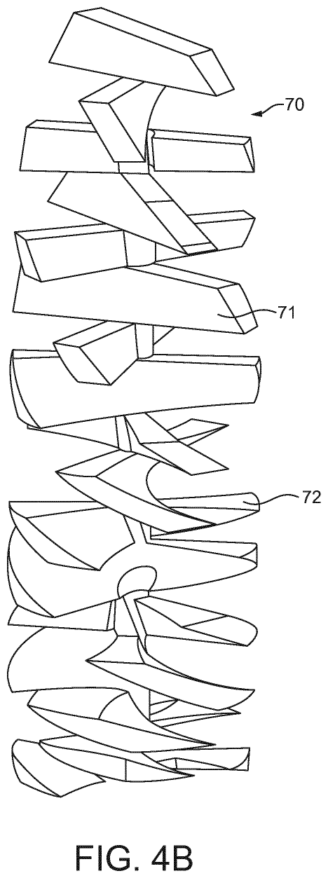

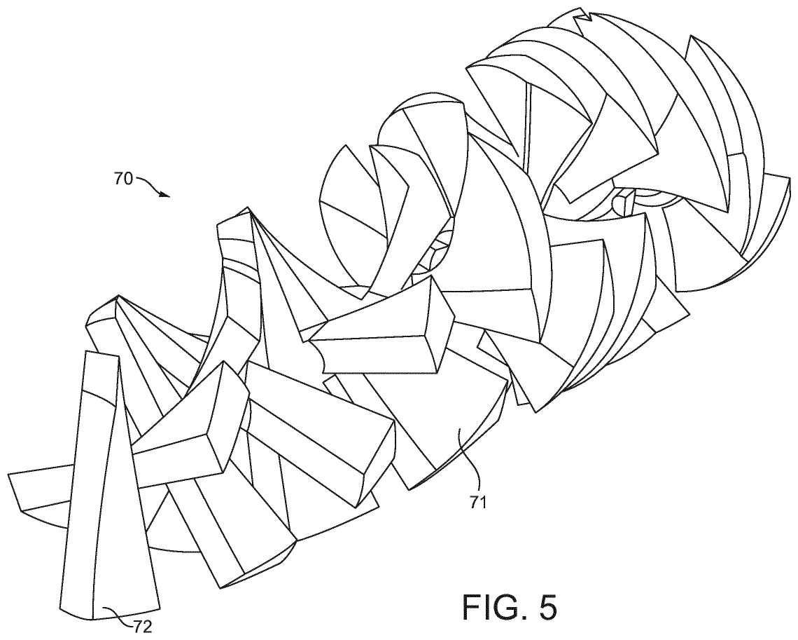

A variable configurable reconstitution and deposition device 70, according to another possible embodiment, is represented in FIGS. 4a-b and 5. This configuration is similar to the one shown in FIGS. 3a and 3b but it is radial instead of longitudinal. A closed configuration of the blades 71 and 72 is shown in FIG. 4a, this configuration being used for dispensing the food product prepared inside the chamber 10. An open configuration of the plurality of blades 71 and 72, as per FIGS. 4b and 5, is used for hydrating and/or reconstituting and/or mixing the food product. The plurality of blades 71 and 72 are moveable with respect to each other in order to adopt an open or a closed configuration. Typically, the plurality of blades 71 and 72 rotate with respect to each other in a radial configuration around a longitudinal axis.

In the variable configurations of the reconstitution and deposition device 70 shown in FIGS. 3a-b, 4a-b and 5, switching from one geometry to a different one (typically from closed to open profiles or the other way round) can be done in different ways:
via simple rotation with a switch limiter, for example such that rotation on one direction opens the geometry and rotation on the opposite direction closes the geometry: this configuration has the advantage of allowing two processes (typically mixing and dispensing) with the same tool though it is limited to the directions (mixing occurs in one direction and dispensing in the opposite direction);
via a switch that can be manually or automatically commanded, so one or the other geometry is activated, so rotation is not function of the direction.

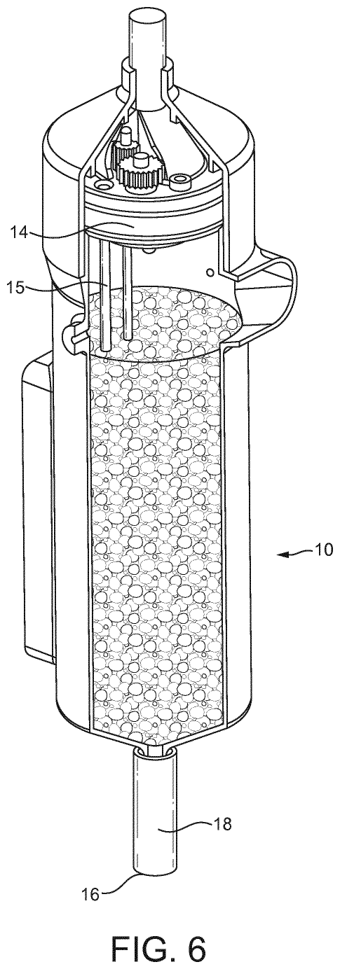

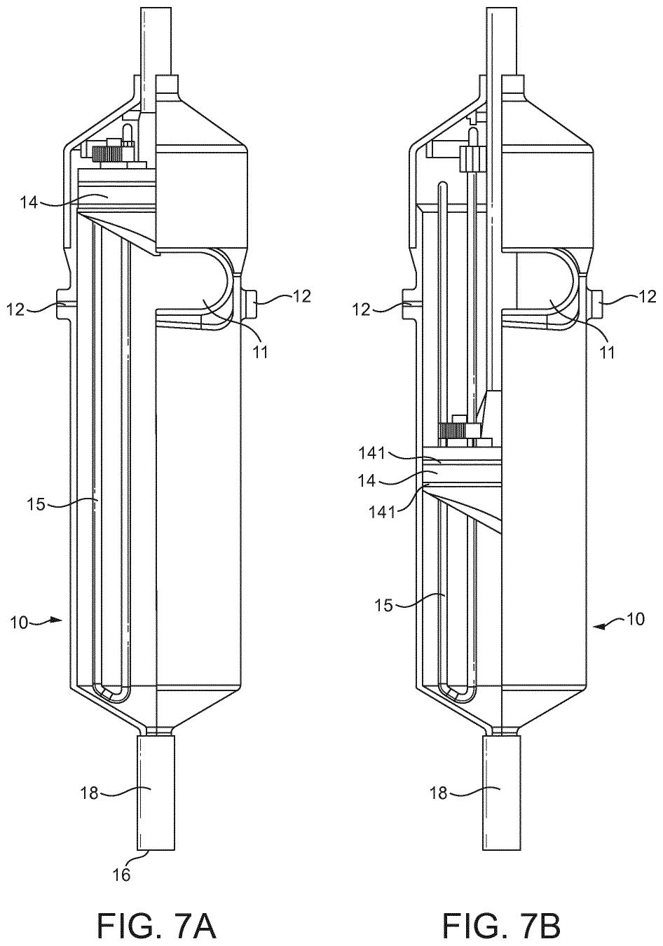

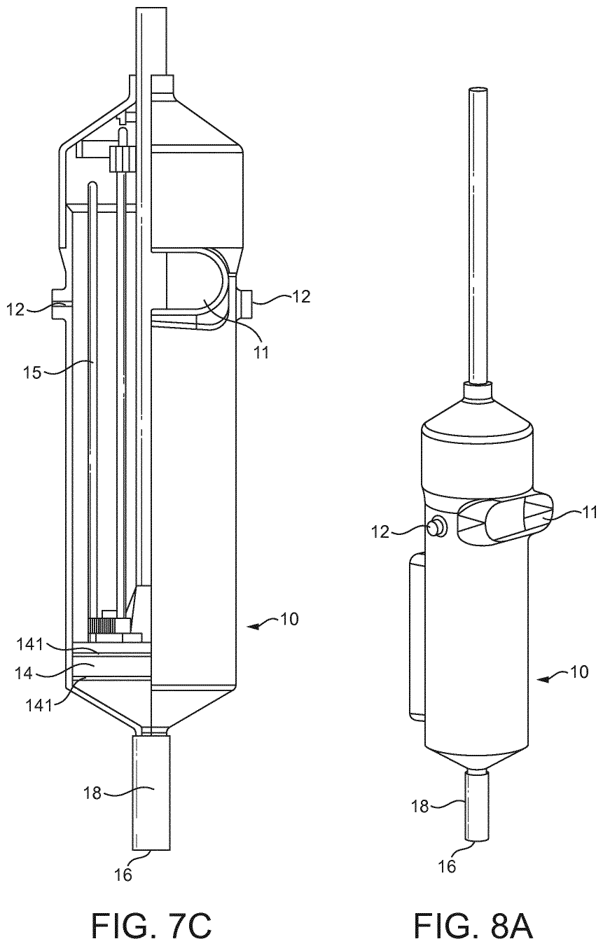

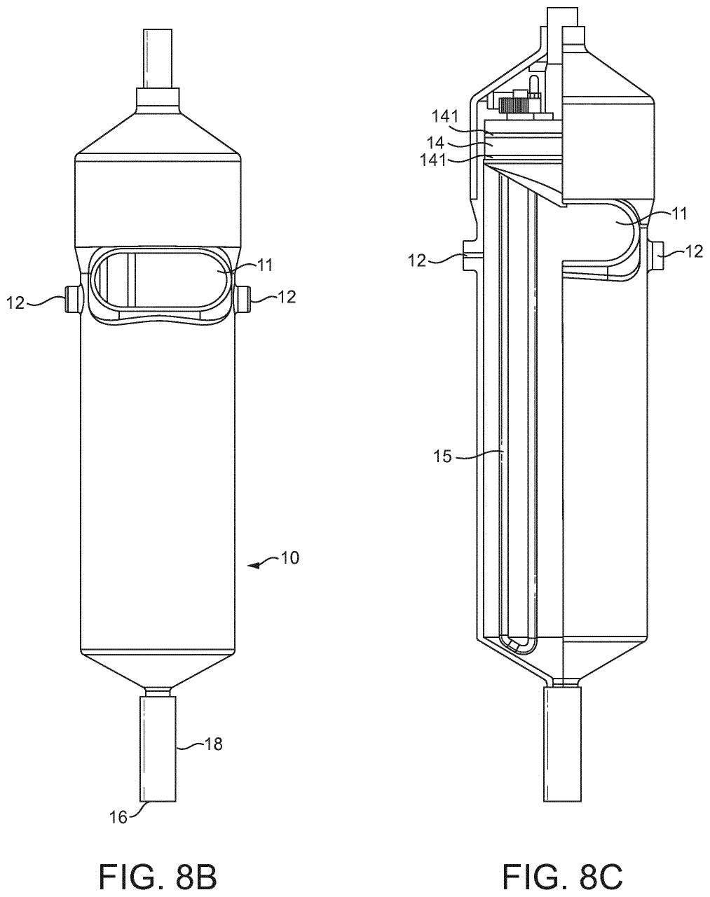

FIGS. 6, 7a-b-c and 8 a-b-c show a further configuration of the dispensing and reconstituting chamber 10, according to another embodiment of the system of the invention. The chamber 10 comprises a rotating mixer 15 that is used to mix, hydrate and reconstitute the food product inside together with fluid provided (typically water). The mixer 15 rotates inside the chamber 10 around a longitudinal axis and, once the mixture is prepared, it is expelled or dispensed by means of a piston 14 displacing downwards and compressing the mixture inside so it is further dispensed. The food product so prepared is expelled via an outlet 16, the opening of which is controlled via a pinching clamp 18. The clamp 18 can be remotely commanded and it will pinch and close the outlet 16 while the product is being prepared inside the chamber 10 (the rotating mixer 15 is rotating inside) and will stop pinching, thus opening the exit for the product to be dispensed, when the piston 14 moves downwards and expels the product. FIG. 7a shows the fluid inlet 12 and the food inlet 11 and the piston 14 in an upper position (FIG. 7a) and in a lower position (FIG. 7b). The piston 14 is provided with one or more joints 141, preferably elastomeric joints that allow tightness of the piston 14 with the inner walls of the chamber 10. FIG. 7c represents the positioning of the piston on the lower part of the chamber 10, when all the mixture has been expelled. The piston 14 is configured to be able to move downwards through the rotating mixer 15: as represented in FIG. 7b or 7c, the piston 14 comprises apertures to go through the mixer 15 while moving downwards and dispensing the food product prepared through the outlet 16.

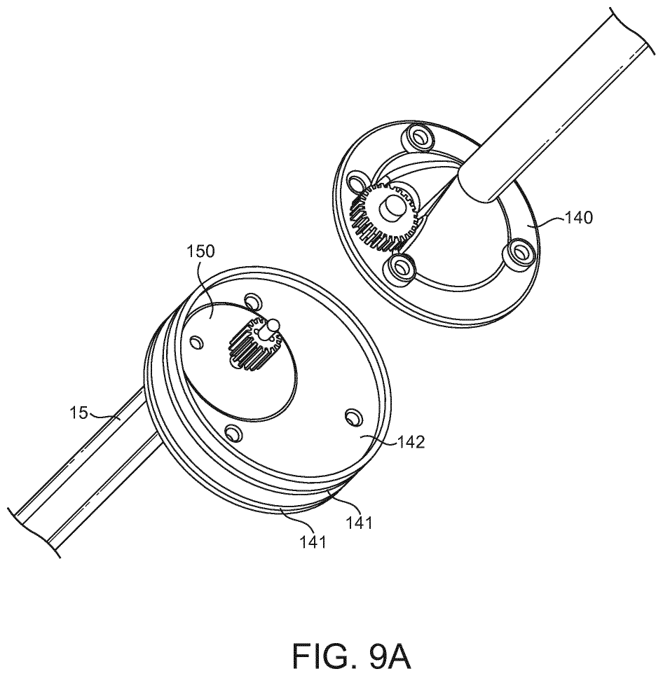

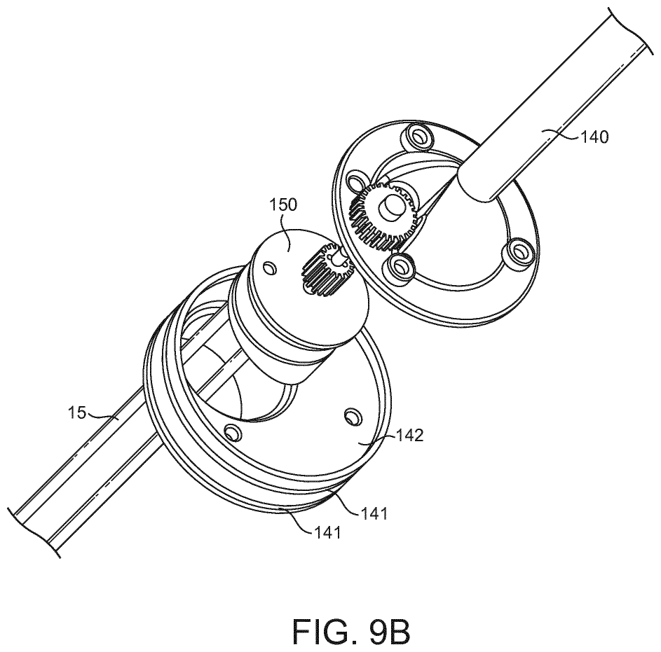

Looking at FIG. 9a, the piston 14 is made up of several parts or subassemblies: a piston subassembly 140 on the upper part of the piston and connected to a motor driving in rotation the mixer 15 and to a motor (same or different) to move downwards the piston; a tightness subassembly 142, comprising the tightness joints 141, where a rotating mixer subassembly 150 is arranged, the mixer subassembly 150 comprising the rotating mixer 15 (the displacement of the mixer 15 in translation being prevented by its blocking via the piston subassembly 140).

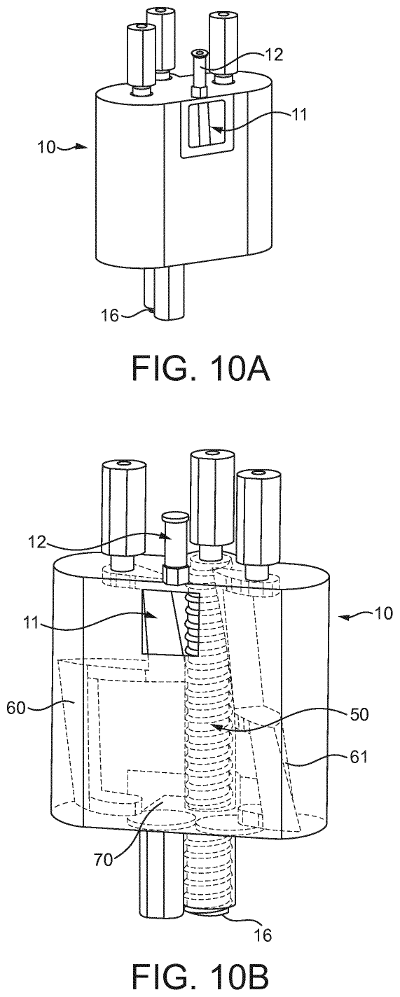

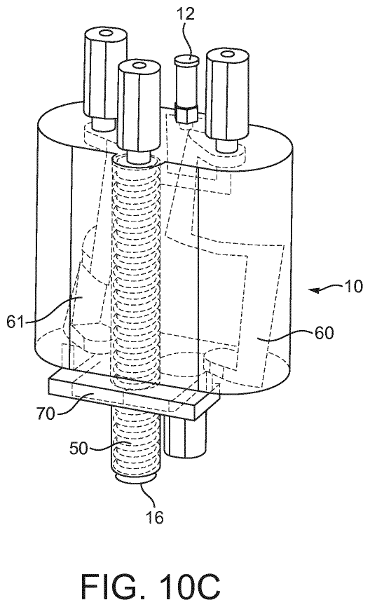

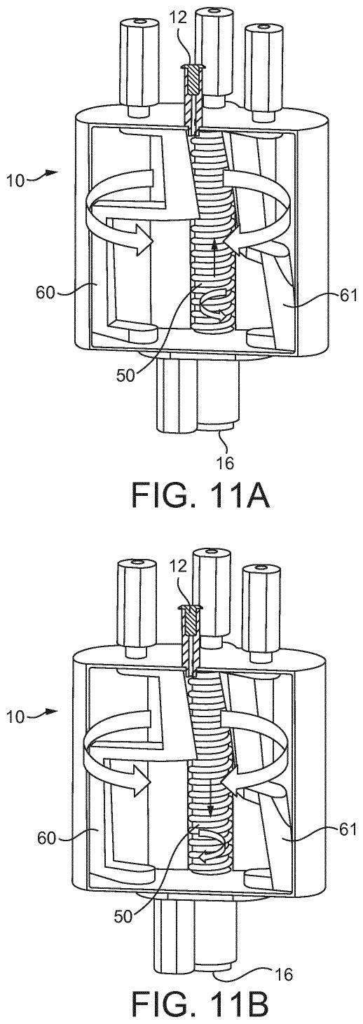

Still another possible configuration of the dispensing and reconstituting chamber 10 is shown in FIGS. 10 a-b-c and 11a-b. FIG. 10a shows the chamber 10 comprising an upper food inlet 11 and an upper fluid inlet 12. The chamber 10 further comprises on its lower side an outlet 16 through where the prepared food product is dispensed. The reconstitution and deposition device 70 comprises a pair of blades 60 and 61 typically shaped in “Z” that rotate around longitudinal respective axis, and that mix, hydrate and reconstitute the food product into the prepared mass that will be later dispensed. The device 70 further comprises an extrusion screw 50, rotating around its own longitudinal axis: the screw 50 rotates and dispenses the prepared food product through the outlet 16. FIGS. 11a and 11b show in more detail the inner configuration of the dispensing and reconstituting chamber 10 according to this third embodiment, further showing the rotational movements of the extrusion screw 50 and the blades in “Z” 60 and 61.

Looking at FIG. 11a, the mixing, hydrating and/or reconstituting phase is shown: the blades 60, 61 rotate in opposing directions for a good mixing of the product inside the chamber 10. At the same time, the extrusion screw 50 rotates in counter-clockwise direction in order to conduct the product inside the chamber 10 for a correct mixing. The blades 60, 61 rotate at different speeds typically, and while the mixing is taking place, the outlet 16 remains closed, so no product is delivered. The dispensing phase is shown in FIG. 11b: the blades 60, 61 rotate in opposing directions so to conduct the product mass towards the extrusion screw 50. The rotation direction of the screw 50 is inversed so to conduct the product prepared towards the outlet 16, which is opened in order to allow the product be expelled and dispensed.

As explained, there are different possible configurations for the dispensing and reconstituting chamber 10 and, in particular, for the reconstitution and deposition device. This device can be configured as one element able to adopt different configurations or the device can comprise two elements, coexisting in the same chamber 10, one for mixing and another one for dispensing. When having two elements, they can be moved by two different motors that can act independently activating the elements sequentially or simultaneously, as the need may be, at the same or different speed and/or direction. Another possibility is that the tools for mixing and dispensing are not at the same time in the chamber 10 but are changed when one or the other operation is performed.

When not shown, the one or more dispensing and reconstituting chambers 10 can be further provided with sensing means that measure characteristics of the product prepared therein such as temperature, viscosity, pH, for example, or with sensing means to measure characteristics of the process carried out in the chambers 10 such as motor torque, motor current or the like. Means can also be provided in the chambers 10 to measure the deposition flow rate of the deposited food product.

According to the invention, the containers 20 typically comprise identification means with information on the type of food product they contain and also with the information on its optimal processing in a chamber 10, as to mixing time and speed, degree of hydration, temperature, optimal dispensing flow rate, or the like. The system of the invention will comprise a control unit able to retrieve the information from the containers and controlling the correct processing in the chamber 10.

The system of the invention can also comprise heating means arranged in the chamber 10 in order to provide the product processed inside with the correct desired temperature, along the time it is processed inside: this can also help for the better mixing of the product mass inside the chamber and also to an easier delivery of it. The system 100 can be further provided with cooking means to cook at least part of the deposited food product on the deposition area 600.

According to a second aspect, the invention further relates to a method for operating a food processing system 100 as the one described to prepare an edible mass of food product from raw food material from one or a plurality of the containers 20, typically according to a certain recipe. The information on the type of product and on its processing is comprised in each of the food containers 20, on identification means in these containers. It is also possible that the information is retrieved from a database connected to the system 100. The information on the identification means of the containers 20 and/or in the remotely accessed database comprises the information on the processing to be followed in the dispensing and reconstituting chamber 10 for obtaining an optimal food product mass from one or more of the raw food products retrieved from one or more of the containers, typically acting on the hydration ratio and/or mixing speed and/or mixing time and/or temperature and/or viscosity and/or texture.

In the method of the invention, the user typically sets or defines a certain recipe in the system, preferably by choosing amongst one of the proposed recipes given by the system, according to the available food in the available containers 20. This can be set up by the user through a HMI for example, that will communicate to a control unit in the system. The control unit will then run the recipe and will take the desired quantities from the one or plurality of containers, processing the food materials in the chamber 10 as per the information retrieved from the cartridges or from the database running the recipe.

In order to have an optimal control of the process, different parameters will be measured and controlled along time in the method of the invention, such as the hydration ratio of the food mass being prepared in the chamber 10, the mixing speed or rotational speed of the rotating mixer 15 or of the reconstitution and deposition device 70, the mixing time during which the food mass is processed inside the chamber 10, the temperature of the food mass inside the chamber, amongst others. Furthermore, the values of these parameters will differ according to the type of food mass processed in the chamber; certain values will be needed along time in order to have an optimal food mass processing, this being controlled by the method of the invention. Because the processing in the chamber 10 is done differently and depending on the type of product processed, it can be done in batches and with different processing for the different products prepared: for example, a first food mass can be prepared in the chamber, processed, then a different raw material in the form of pieces, chunks or the like can be added, and then the complete mixture will be later re-mixed for homogenization and will be deposited at the end of its processing.

Cooking means can also be provided in the system of the invention, allowing to cook at least part of the food mass deposited onto the deposition area 600: the deposition can be done layer by layer, so the cooking can also be effected layer by layer. Also, the control unit can control cooking up to the moment when a certain degree of volume of the deposited mass has been reached for example, or up to the moment when a certain reaction on the deposited mass has been reached. Different reactions can be controlled depending on the food products prepared by the system, and also different reaction levels can also be monitored.

One of the main advantages of the present invention is to be able to process in batches more than one food mass, in the case where more than one dispensing and reconstituting chamber is present in the system 100. In that case, one chamber 10 will be preparing a food mass, and will dispense it onto the deposition area 600 while a second chamber 10 will be preparing a second food mass in “hidden time”. The second food mass will then be ready for being dispensed once the first food mass has been deposited, and the first chamber will prepare a third mass while the second is being dispensed. The method in batches of the invention makes it possible to provide very efficient processes with the system of the invention.

Some of the advantages of the system and of the method of the invention are the following:
the mixing, reconstitution and/or hydration time can be controlled according to the product prepared, as some products need more time than others;
different products can be prepared out of different products mixed coming from different containers 20;
a sequence can be done according to a certain recipe and with content of one or more of the containers 20 (for example, a powder from one container can be mixed with water to create a paste and, in the end, chunks or pieces can be added to the mixture just before it will be dispensed);
when the system 100 comprises more than one dispensing and reconstituting chamber 10, it is then possible to have processes in hidden time, for example one dispensing and reconstituting chamber will be dispensing while a second one will be preparing a second product in batch.

Although the present invention has been described with reference to preferred embodiments thereof, many modifications and alternations may be made by a person having ordinary skill in the art without departing from the scope of this invention which is defined by the appended claims.

1. Food processing system for preparing an edible mass of a food product starting from a raw food material, the system comprising:
one or a plurality of food containers, each one comprising a raw food material; and
one or a plurality of dispensing and reconstituting chambers each chamber being associated to at least one food container each of the chambers comprising a variable and/or exchangeable reconstitution and deposition device configured for hydrating and/or structuring and/or reconstituting in batches the raw food material provided by the one or more food containers in order to create a homogeneous edible mass of food product, the device being further configured to deposit in-line with a controlled flow the edible mass of food product once prepared.

2. Food processing system according to claim 1 wherein the one or plurality of dispensing and reconstituting chambers is relatively moveable with respect to the one or plurality of food containers and/or is relatively moveable with respect to a deposition area where the mass of food product is deposited.

3. Food processing system according to claim 1 wherein the reconstitution and deposition device is configured as a unique device, configurable under two different profiles, one for hydrating and/or structuring and/or reconstituting and another one for depositing.

4. Food processing system according to claim 3 wherein the reconstitution and deposition device can adopt the different profiles by rotating in opposite directions or by manual or commanded switching.

5. Food processing system according to claim 1 wherein the reconstitution and deposition device comprises exchangeable tools for hydrating and/or structuring and/or reconstituting, and for depositing, working sequentially within the same dispensing and reconstituting chamber.

6. Food processing system according to claim 1 wherein the reconstitution and deposition device comprises two distinct tools for hydrating and/or structuring and/or reconstituting, and for depositing, coexisting in the same dispensing and reconstituting chamber, the tools being activated separately or in combination according to the needs for hydrating and/or structuring and/or reconstituting, and for depositing.

7. Food processing system according to claim 6 wherein the two distinct tools are activated by two distinct motors, independently commanded, the activation of these tools being done simultaneously or sequentially, at the same or different speed and/or direction.

8. Food processing system according to claim 1 wherein one or more of the dispensing and reconstituting chambers are provided with an injection member for a controlled and homogenous water injection into the chamber, in the form of a jet, a spray or the like.

9. Food processing system according to claim 1 wherein one or more of the dispensing and reconstituting chambers are provided with a sensing member to measure one or more characteristics of the edible mass of the food product prepared therein.

10. Food processing system according to claim 1 wherein one or more of the dispensing and reconstituting chambers are provided with a sensing member to measure the deposition flow rate of the edible mass of food product prepared.

11. Food processing system according to claim 1 wherein one or more of the dispensing and reconstituting chambers are provided with a heating member to control the temperature of the edible mass of food product prepared therein.

12. Food processing system according to claim 1 wherein one or more of the food containers comprise an identification member with information to identify the kind of raw food material contained and the information on its processing according to a certain recipe.

13. Food processing system according to claim 1 further comprising a cooking member able to cook at least part of the edible mass of food product deposited onto the deposition area.

14. Method for operating a food processing system for preparing an edible mass of a food product starting from a raw food material, the system comprising one or a plurality of food containers, each one comprising a raw food material, and one or a plurality of dispensing and reconstituting chambers, each chamber being associated to at least one food container, each of the chambers comprising a variable and/or exchangeable reconstitution and deposition device configured for hydrating and/or structuring and/or reconstituting in batches the raw food material provided by the one or more food containers in order to create a homogeneous edible mass of food product, the device being further configured to deposit in-line with a controlled flow the edible mass of food product once prepared in order to prepare an edible mass of food product starting from raw food material, wherein the information on the kind of raw food material and on its processing is retrieved from an identification member on the one or more food containers and/or from a connected database, in order to process the raw food material in the one or more of the dispensing and reconstituting chambers according to a certain recipe, acting on the hydration ratio and/or mixing speed and/or mixing time and/or temperature and/or viscosity and/or texture.

15. Method according to claim 14 wherein the temperature of the edible mass of food product in the one or plurality of dispensing and reconstituting chambers is controlled along time and depending on the type raw food material being processed therein.

16. Method according to claim 14 wherein a different raw material in the form of chunks, pieces or the like is added to the one or plurality of dispensing and reconstituting chambers after a first processing of edible mass has started, the complete mixture being later re-mixed for homogenization and further deposition.

17. Method according to claim 14 wherein the edible mass of food product from one or a plurality of dispensing and reconstituting chambers is deposited onto a deposition area, where it is then treated by being cooked at least partially and/or it is controlled for a certain reaction such as a volume increase, before a further edible mass is deposited onto the area.

18. Method according to claim 14 wherein the edible mass of food product prepared by one or more of the dispensing and reconstituting chambers is deposited in different steps, while the dispensing and reconstituting chambers continue processing the food mass contained therein in order to maintain certain characteristics of the food mass, typically its viscosity.

19. Method according to claim 14 wherein part of the content of the edible food mass in one of the dispensing and reconstituting chambers is dispensed onto a deposition area, while the remaining food mass in the chamber is mixed with a different product in the form of chunks and/or pieces, which will be deposited further onto the area having a different texture than the one of the first mass deposited.
